(19) United States
(12) Patent Application Publication
(10) Pub. No.: US 2011/0074795 A1
(43) Pub. Date: Mar. 31, 2011

(54) GRAPHIC DATA PROCESSING MODULE AND DATA LINE DRIVING CIRCUIT USING THE SAME

(75) Inventors: GUANG-CONG LI, Shenzhen City (CN); SAI-XIN GUAN, Shenzhen City (CN)

(73) Assignees: INNOCOM TECHNOLOGY (SHENZHEN) CO., LTD., Shenzhen City (CN); INNOLUX DISPLAY CORP., Miao-Li County (TW)

(21) Appl. No.: 12/712,378

(22) Filed: Feb. 25, 2010

(30) Foreign Application Priority Data
Sep. 30, 2009 (CN) 200910307990.2

(51) Int. Cl. G09G 3/36; G06F 13/14

(52) U.S. Cl. 345/520; 345/559; 345/100; 345/213

(57) ABSTRACT

A graphic data processing module includes a system interface for receiving image data streams, a shift register connected to the system interface, a timing generator connected to the system interface and the shift register, and a graphic display data random access memory (GDDRAM) connected to the shift register. The timing generator generates a clock signal and inputs the clock signal to the shift register, the shift register is controlled by the clock signal to receive image data streams in a first format from the system interface and convert the data of each pixel in the image data streams into data in a second format using fewer bits than the first format, and the data in the second format is transmitted to the GDDRAM.

### BACKGROUND

1. Technical Field

The present disclosure relates to graphic data processing, and particularly to a graphic data processing module converting data, and a data line driving circuit using the same.

2. Description of Related Art

Most liquid crystal displays (LCD) include data line driving circuits for determining the times of displaying the pixels of the LCD. Other parameters of displaying the pixels, such as brightness and grayscale, can also be regulated by the data line driving circuits.

Referring to FIG. 4, a conventional data line driving circuit 100 comprises an oscillator 110, a graphic data processing module 105, a graphic selection and display module 170, a power management unit (PMU) 160, and a source driver 180. The oscillator 110, the graphic data processing module 105, the graphic selection and display module 170, and the source driver 180 are connected in series, and the PMU 160 is connected to the graphic selection and display module 170. The graphic data processing module 105 includes a timing generator 120, an address counter 140, a graphic display data random access memory (GDDRAM) 150, and a system interface 130 for inputting signals and data to the data line driving circuit 100 in a predetermined format. The system interface 130 is connected to the timing generator 120 and the GDDRAM 150. The oscillator 110 is connected to the timing generator 120. The timing generator 120 is connected to the GDDRAM 150 via the address counter 140. The GDDRAM 150 is connected to the graphic selection and display module 170.

In use, the oscillator 110 cooperates with the timer generator 120 to generate a clock signal. The system interface 130 presents the clock signal in a predetermined format. An image data stream is then input into the data line driving circuit 100 through the system interface 130. The address counter 140 counts the addresses of the data of the pixels in the image data stream to be stored in the GDDRAM 150 or read from the GDDRAM 150 according to the clock. The GDDRAM 150 temporarily stores the data of the pixels in the predetermined format, and transmits the data of the pixels in series. The graphic selection and display module 170 temporarily stores the output data, and cooperates with the PMU 160 to determine relevant parameters for displaying the pixels corresponding to the stored data, such as electric potentials, grayscales, luminosity, and others. Thus, the source driver 180 can drive the data lines of an LCD to display the pixels corresponding to the stored data, according to the predetermined parameters.

In the data line driving circuit 100, the system interface 130 generally presents the clock signal and the image data stream in an eight-bit format (the data of each pixel comprising eight bits). Correspondingly, the timing generator 120 and the address counter 140 also function in the eight-bit format. However, many LCDs work in a six-bit format (the data of each pixel comprising six bits), and cannot work in the eight-bit format. Thus, eight-bit format data line driving circuits, such as the data line driving circuit 100, are not compatible with the six-bit format LCD.

Therefore, there is room for improvement within the art.

### BRIEF DESCRIPTION OF THE DRAWINGS

Many aspects of the present graphic data processing module and data line driving circuit using the same can be better understood with reference to the following drawings. The components in the various drawings are not necessarily drawn to scale, the emphasis instead being placed upon clearly illustrating the principles of the present graphic data processing module and data line driving circuit using the same. Moreover, in the drawings, like reference numerals designate corresponding parts throughout the figures.

FIG. 1 is a block diagram of a data line driving circuit, according to an exemplary embodiment.

FIG. 2 is a circuit diagram of one embodiment of a shift register shown in FIG. 1.

FIG. 3 is a schematic view of one example of a working signal wave curve of the shift register shown in FIG. 1.

FIG. 4 is a block diagram of a conventional data line driving circuit.

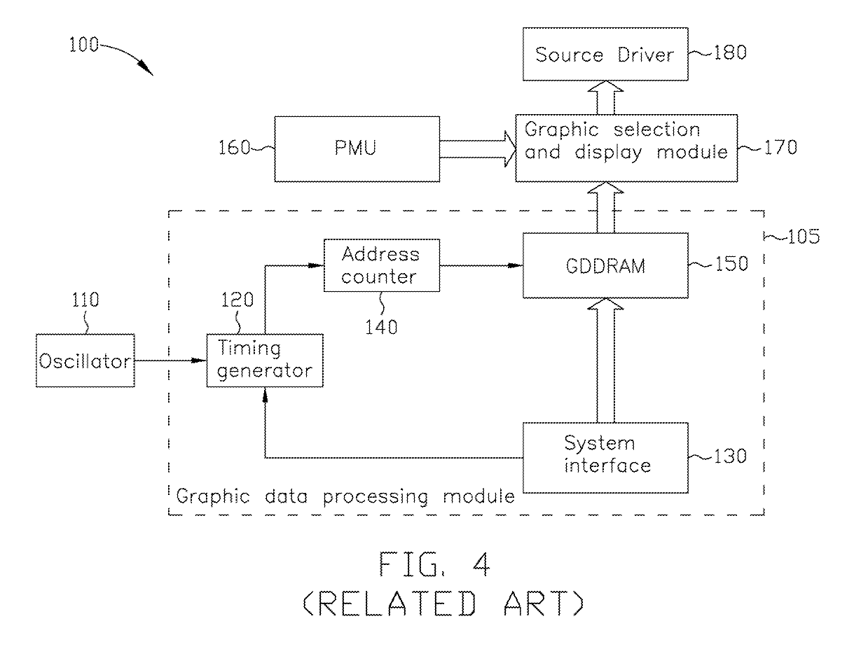

### DETAILED DESCRIPTION

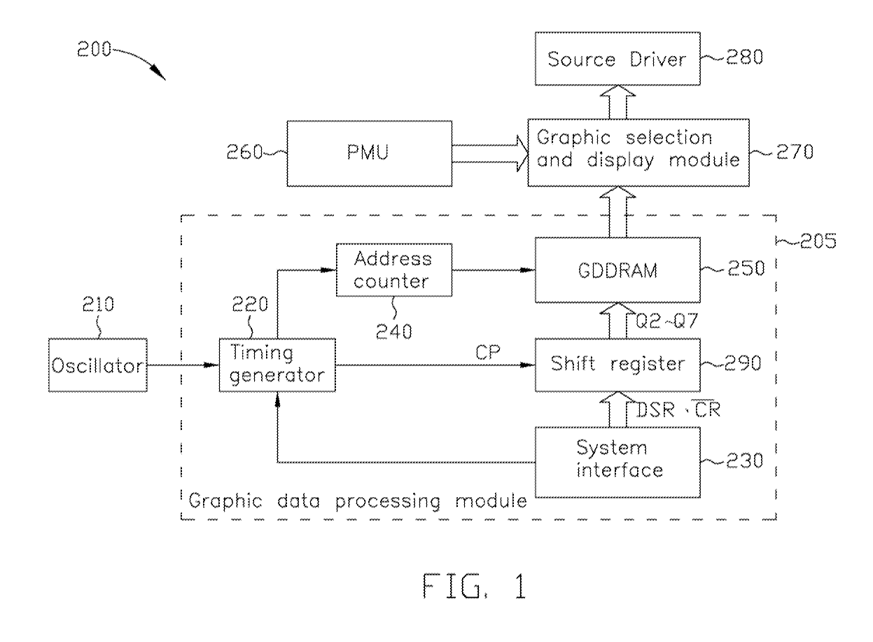

FIG. 1 shows a data line driving circuit 200, according to an exemplary embodiment. The data line driving circuit 200 includes an oscillator 210, a graphic data processing module 205, a graphic selection and display module 270, a power management unit (PMU) 260, and a source driver 280. The oscillator 210, the graphic data processing module 205, the graphic selection and display module 270, and the source driver 280 are connected in series, and the PMU 260 is connected to the graphic selection and display module 270. The graphic data processing module 205 includes a timing generator 220, an address counter 240, a graphic display data random access memory (GDDRAM) 250, a shift register 290, and a system interface 230. The system interface 230 is connected to the timing generator 220 and the shift register 290. The oscillator 210 is connected to the timing generator 220. The timing generator 220 is connected to the address counter 240 and the shift register 290. The address counter 240 and the shift register 290 are both connected to the GDDRAM 250. The GDDRAM 250 is connected to the graphic selection and display module 270.

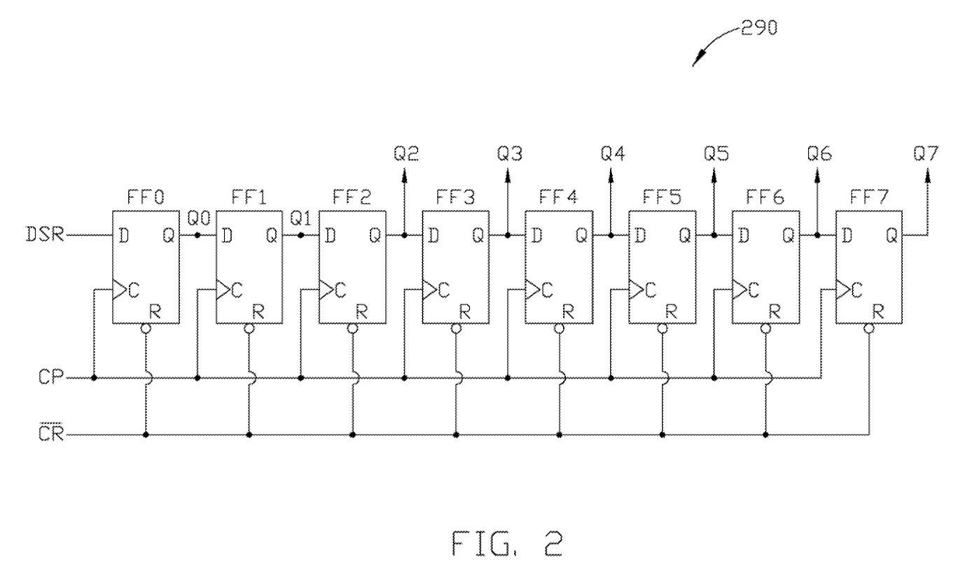

Also referring to FIG. 2, the shift register 290 includes eight D flip-flops FF0, FF1, FF2, FF3, FF4, FF5, FF6, FF7 connected in series and in order. The D flip-flops FF0-FF7 are positive-edge triggered. The data input connector D of the D flip-flop FF0 is connected to the system interface 130 to receive image data streams (DSR), and each data input connector D of the other seven D flip-flops FF1-FF7 is connected to the output connector Q of its previous D flip-flop (i.e., the output connectors of the D flip-flops FF0-FF6). The output connectors Q of the D flip-flops FF2-FF7 are all connected to the GDDRAM 250. The timing input connectors C of the D flip-flops FF0-FF7 are all connected to the timing generator 220 to receive the clock pulses (CP) generated by the timing generator 220. The clear connectors R of the D flip-flops FF0-FF7 are all connected to the system interface 130 to receive a clear signal (CR). When the clear signal is at a low voltage level (e.g., a logical 0), the D flip-flops FF0-FF7 can be reset.

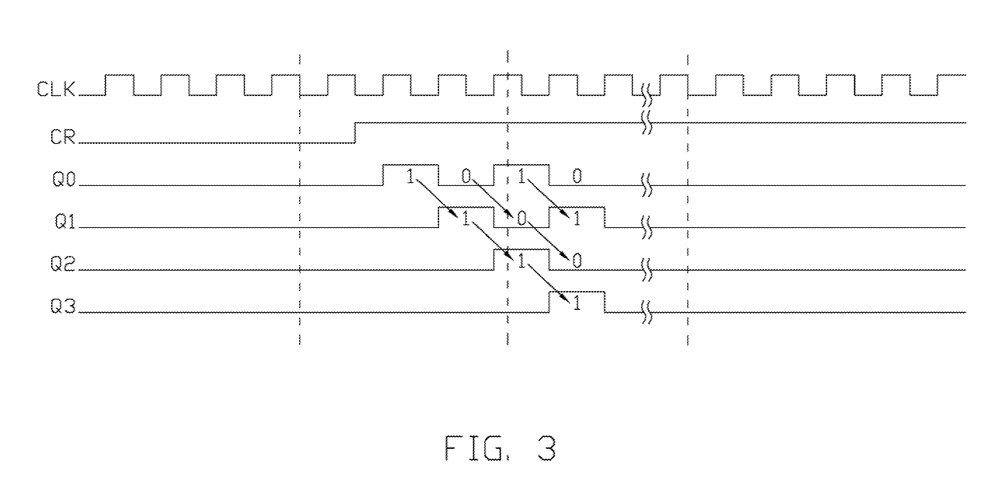

Also referring to FIG. 3, when the data line driving circuit 200 is used, a clear signal (CR) at a low voltage level is input to the D flip-flops FF0-FF7 via the system interface 130 to reset the D flip-flops FF0-FF7. The oscillator 210 cooperates with the timing generator 220 to generate a clock signal (CLK) comprising sequential clock pulses and inputs the clock signal into the D flip-flops FF0-FF7, such that the D flip-flops FF0-FF7 are periodically triggered during the rising edges of each clock pulse. An image data stream in an eight-bit format (the data of each pixel comprising eight bits) is then input into the system interface 230. The image data stream can be input into the shift register 290 through the system interface 230 when the D flip-flops FF0-FF7 are triggered, that is, during the rising edges of the clock signal.

In the graphic data processing module 205, data of each pixel in the image data stream is processed as follow. When the D flip-flops FF0-FF7 are first triggered after the data of a pixel in the eight-bit format is input to the shift register 290, the most significant bit of the data is first input into and temporarily stored in the D flip-flop FF0 during a predetermined rising edge of the clock signal. When a next rising edge of the clock signal is input into the D flip-flop FF0, the most significant bit is transmitted from the D flip-flop FF0 to the next D flip-flop FF1, and a second most significant bit is input into and stored in the D flip-flop FF0. Similarly, during each subsequent rising edge of the clock signal, each D flip-flop transmits the bit stored therein to its next D flip-flop that is connected in series. A next bit of the data, which is less significant than the previous bit(s) (in terms of bit order), is input into the D flip-flop FF0. After eight clock pulses of the clock signal, each of the D flip-flops FF0-FF7 stores a bit, and thus the shift register 290 stores all data of the pixel in an eight-bit format. In the eight bits of the stored data, each of the bits correspondingly stored in the D flip-flops FF7, FF6, FF5, FF4, FF3, FF2, FF1 is more significant than its next bit, and the least significant bit is input last into and stored in the D flip-flop FF0.

After the shift register 290 stores all data of the pixel in an eight-bit format, the data is transmitted to the GDDRAM 250. Since only the D flip-flops FF2-FF7 are connected to the GDDRAM 250, only the output signals Q2-Q7 of the D flip-flops FF2-FF7 are transmitted to the GDDRAM 250, and the output signals Q0, Q1 of the D flip-flops FF0, FF1 cannot be transmitted to the GDDRAM 250. Thus, six more significant bits of the pixel data are transmitted to the GDDRAM 250, and the two least significant bits of the pixel data are omitted. In this way, the data of the pixel transmitted to the GDDRAM 150 has six bits, that is, is converted to a six-bit format by the graphic data processing module 205. Since the omitted bits are the two least significant bits, the precision of the pixel data is not essentially influenced by the conversion from the eight-bit format to the six-bit format.

After the pixel data is converted, the address counter 240 counts the addresses of the pixel data stored in the GDDRAM 250. The GDDRAM 250 temporarily stores the pixel data in the six-bit format, and transmits the pixel data to the graphic selection and display module 270. The graphic selection and display module 270 temporarily stores the output data, and cooperates with the PMU 260 to determine relevant parameters for displaying the pixel, such as electric potentials, grayscales, luminosity, and others. Thus, the source driver 280 can direct the data lines of an LCD to display the pixel, according to the predetermined parameters.

Since the pixel data stored by the GDDRAM 250 and transmitted to the graphic selection and display module 270 is in the six-bit format, the graphic selection and display module 270, the PMU 260, and the source driver 280 correspondingly function in the six-bit format. Thus, the data line driving circuit 200 can drive the data lines of a six-bit format LCD to display the pixel corresponding to the data in the six-bit format. Afterwards, the shift register 290 can be reset, and the data line driving circuit 100 can convert data of a next pixel and drive the data lines of the LCD to display the next pixel. In this way, the data of each pixel in the eight-bit format image data stream input to the shift register 290 via the system interface 230 can be converted to six-bit format data and displayed in the six-bit format LCD. Thus, the data line driving circuit 200 can be used in the six-bit format LCD to drive the data lines of the LCD to display images in the six-bit format. As described, despite eight-bit pixel data stream input to the data line driving circuit 200, the data line driving circuit 200 is compatible.

In the shift register 290, the total number of all D flip-flops and the number of the D flip-flops connected to the GDDRAM 250 can be changed. Particularly, the total number of all D flip-flops should be greater than the number of the D flip-flops connected to the GDDRAM 250. The total number of all D flip-flops is set to equal the number of bits used by original data input into the shift register 290, and the number of the D flip-flops connected to the GDDRAM 250 is set to equal the number of bits used by converted data output from the shift register 290. In use, according to the above-detailed method, all bits of the original data are respectively stored in all D flip-flops, where predetermined more significant bits of the original data are respectively stored in the D flip-flops connected to the GDDRAM 250. When the stored data is output to the GDDRAM 250 from the shift register 290, only the more significant bits of the original data are output to the GDDRAM 250 from the D flip-flops connected to the GDDRAM 250. Thus, the original data using more bits is converted to data using less bits (i.e., only using the significant bits). For example, when the data line driving circuit 200 is used to convert data in a six-bit format to data in a four-bit format, the shift register 290 is configured to include six D flip-flops, and four of the six D flip-flops for storing four more significant bits of the original data are connected to the GDDRAM 250 to output the four more significant bits to the GDDRAM 250. When the data line driving circuit 200 is used to convert data in a 100-bit format to data in a 90-bit format, the shift register 290 is configured to include 100 D flip-flops, and 90 of the 100 D flip-flops for storing 90 more significant bits of the original data are connected to the GDDRAM 250 to output the 90 more significant bits to the GDDRAM 250. Similarly, the data line driving circuit 200 can convert data in any format using more bits into data in any other format using fewer bits.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A graphic data processing module, comprising:
a system interface for receiving image data streams;
a shift register connected to the system interface;
a timing generator connected to the system interface and the shift register; and
a graphic display data random access memory (GDDRAM) connected to the shift register; wherein the timing generator generates a clock signal and inputs the clock signal to the shift register, the shift register is controlled by the clock signal to receive image data streams in a first format from the system interface and convert the data of each pixel in the image data streams into data in a second format using fewer bits than the first format, and the data in the second format is transmitted to the GDDRAM.

2. The graphic data processing module as claimed in claim 1, wherein the shift register includes a plurality of D flip-flops corresponding to the bits of the data of each pixel in the first format, the number of the plurality of D flip-flops being greater than the number of D flip-flops of the plurality of D flip-flops connected to the GDDRAM, and the D flip-flops connected to the GDDRAM corresponding to the bits of the data of each pixel in the second format.

3. The graphic data processing module as claimed in claim 2, wherein all D flip-flops are connected in series, the data input connector of a first D flip-flop connected to the system interface receives the image data streams, and each data input connector D of the other D flip-flops is connected to the output connector of its previous D flip-flop.

4. The graphic data processing module as claimed in claim 3, wherein the D flip-flops connected to the GDDRAM are the last of the series of all D flip-flops arranged from the first D flip-flop.

5. The graphic data processing module as claimed in claim 4, wherein all bits of the data of each pixel in the first format are input into the shift register from the most significant bit to the least significant bit, and the D flip-flops are controlled by the clock signal to transmit each bit from the first D flip-flop connected to the system interface to the subsequent D flip-flops one by one, such that all bits of the pixel data in the first format are correspondingly stored in all D flip-flops, each bit stored in a previous D flip-flop less significant than the bit stored in a next D flip-flop, and all the bits stored in the D flip-flops connected to the GDDRAM are more significant than the other bits.

6. The graphic data processing module as claimed in claim 5, wherein only the bits stored in the D flip-flops connected to the GDDRAM are transmitted to the GDDRAM, such that the data of the pixel in the first format is converted to the data of the pixel in the second format.

7. The graphic data processing module as claimed in claim 2, wherein the timing input connectors of all D flip-flops are connected to the timing generator to receive the clock pulses.

8. The graphic data processing module as claimed in claim 2, wherein the clear connectors of all D flip-flops are connected to the system interface to receive a clear signal to reset the D flip-flops.

9. The graphic data processing module as claimed in claim 2, wherein the timing generator is connected to the GDDRAM through an address counter.

10. A data line driving circuit used in a liquid crystal display (LCD), comprising:
a graphic data processing module, which includes a system interface for receiving image data streams, a shift register connected to the system interface, a timing generator connected to the system interface and the shift register, and a GDDRAM connected to the shift register; the timing generator generating a clock signal and inputting the clock signal to the shift register, the shift register controlled by the clock signal to receive image data streams in a first format from the system interface and convert the data of each pixel in the image data streams into data in a second format using fewer bits than the first format, and the data in the second format transmitted to the GDDRAM;
a graphic selection and display module connected to the GDDRAM;
a power management unit (PMU) connected to the graphic selection and display module; and
a source driver for driving data lines of the LCD to display images; wherein the data in the second format is transmitted from the GDDRAM to the graphic selection and display module, which cooperates with the PMU to determine relevant parameters for displaying the pixel, and the source driver drives the data lines of the LCD to display the pixel in the second format and according to the predetermined parameters.

11. The data line driving circuit as claimed in claim 10, further comprising an oscillator connected to the timing generator.

12. The data line driving circuit as claimed in claim 10, wherein the shift register includes a plurality of D flip-flops corresponding to the bits of the data of each pixel in the first format, the number of the plurality of D flip-flops being greater than the number of D flip-flops of the plurality of D flip-flops connected to the GDDRAM, and the D flip-flops connected to the GDDRAM corresponding to the bits of the data of each pixel in the second format.

13. The data line driving circuit as claimed in claim 12, wherein all D flip-flops are connected in series, the data input connector of a first D flip-flop connected to the system interface receives the image data streams, and each data input connector D of the other D flip-flops is connected to the output connector of its previous D flip-flop.

14. The data line driving circuit as claimed in claim 13, wherein the D flip-flops connected to the GDDRAM are at the last of the series of all D flip-flops arranged from the first D flip-flop.

15. The data line driving circuit as claimed in claim 14, wherein all bits of the data of each pixel in the first format are input into the shift register from the most significant bit to the least significant bit, and the D flip-flops are controlled by the clock signal to transmit each bit from the first D flip-flop connected to the system interface to the subsequent D flip-flops one by one, such that all bits of the pixel data in the first format are correspondingly stored in all D flip-flops, each bit stored in a previous D flip-flop being less significant than the bit stored in a next D flip-flop, and the bits stored in the D flip-flops connected to the GDDRAM are all more significant than the other bits.

16. The data line driving circuit as claimed in claim 15, wherein only the bits stored in the D flip-flops connected to the GDDRAM are transmitted to the GDDRAM, such that the data of the pixel in the first format is converted to the data of the pixel in the second format.

17. The data line driving circuit as claimed in claim 12, wherein the timing input connectors of all D flip-flops are connected to the timing generator to receive the clock pulses.

18. The data line driving circuit as claimed in claim 12, wherein the clear connectors of all D flip-flops are connected to the system interface to receive a clear signal used to reset the D flip-flops.

19. The data line driving circuit as claimed in claim 12, wherein the timing generator is connected to the GDDRAM through an address counter.
